(19) United States
(12) Patent Application Publication
(10) Pub. No.: US 2024/0003457 A1
(43) Pub. Date: Jan. 4, 2024

(54) PNEUMATIC SPRAY GUN SWITCH VALVE

(71) Applicants: Hai Wu, Taizhou (CN); Fazheng Yang, Taizhou (CN); Xiaorong Li, Taizhou (CN)

(72) Inventors: Hai Wu, Taizhou (CN); Fazheng Yang, Taizhou (CN); Xiaorong Li, Taizhou (CN)

(21) Appl. No.: 17/823,516

(22) Filed: Aug. 31, 2022

(30) Foreign Application Priority Data
Jun. 29, 2022 (CN) 202221642936.0

(51) Int. Cl. F16K 31/00; B05B 7/12

(52) U.S. Cl. CPC F16K 31/003; B05B 7/12

(57) ABSTRACT

A switch valve for comfortable use of pneumatic spray guns. The switch valve is configured inside the switch passage of the gun body, comprising a switch screw seat fixed with the gun body, a switch seat configured on the right side of the switch screw seat, an air valve configured in the middle portion of the switch screw seat and the switch seat, a switch spring configured on the right end of the air valve. The air valve and the switch seat interact to open or close the air passage. The size of the switch spring is smaller than the switch passage. A switch spring pad is configured on the right side of the switch spring.

### BACKGROUND OF INVENTION

### 1. Field of the Invention

The invention relates to a pneumatic spray gun switch valve with good use feeling.

### 2. Description of Related Art

A pneumatic spray gun is a spraying device powered by compressed air. Compressed air is supplied from the air inlet tube into the gun body. When the high-pressure compressed air is ejected from the air cap on the front portion of the spray gun, a zone of negative pressure lower than the atmosphere pressure is created in front of the paint nozzle. Due to the pressure difference in front of the muzzle, the paint is sucked out from the paint storage tank and is atomized into tiny particles by the high-speed ejected compressed air, thus being coated on the surface to be painted. The technology of pneumatic spray guns is already quite mature. However, manufacturers are still making effort in further improvements in terms of optimized structure, better performance, longer life cycle, lower production cost, and simplified assembly, with a view to maintaining their competitive edge in the market.

In the conventional pneumatic spray gun, the switch valve is installed inside the switch passage. To guarantee the stability of the switch spring, the size of the switch spring is basically the same as the diameter of the switch passage. During use of the switch valve, the switch spring will have friction with the inner wall of the switch passage, which will cause a noise during the use of the pneumatic spray gun. Due to the friction between the switch spring and the inner wall of the switch passage, the increased resistance causes uncomfortable gripping.

### SUMMARY OF THE INVENTION

In view of the deficiencies in the above problems, the present invention provides a pneumatic spray gun switch valve with good use feeling.

In order to achieve the above purpose, the present invention provides a pneumatic spray gun switch valve, wherein the switch valve being disposed at a switch passage of a gun body, and comprises a switch screw seat fixedly connected with the gun body, a switch seat configured on a right side of the switch screw seat, an air valve, which is disposed in a middle portion of the switch screw seat and switch seat and can move axially, a switch spring disposed at a right end of the air valve, the air valve interacts with the switch seat to open or close an air passage, the size of the switch spring is smaller than the switch passage, and a right side of the switch spring is configured with a switch spring pad.

More particularly, wherein the switch seat is screwed onto the switch screw seat by a tread, and a spiracle seal ring is configured at a connection position of the switch seat and the switch screw seat.

More particularly, wherein a left end of the air valve is configured with a switch valve, and the switch valve is made of engineering plastics.

Comparing to the prior art, the present invention has the following benefits: Based on the existing switch valve, an extra switch valve is provided on the left side of the air valve to reduce the noise during collision between the trigger and the air valve and to enhance the comfort during gripping. On the right side of the air valve, a switch spring pad is provided. The switch spring pad is used to guide the movement of the switch spring during the compression, so that the size of the switch spring can be smaller than the switch passage, and friction will not occur between the switch spring and the inner wall of the switch passage to cause noises.

### BRIEF DESCRIPTION OF THE DRAWINGS

FIG. 1 is a perspective view of a pneumatic spray gun configured with a switch valve according to the present invention;

FIG. 2 is a sectional view of FIG. 1;

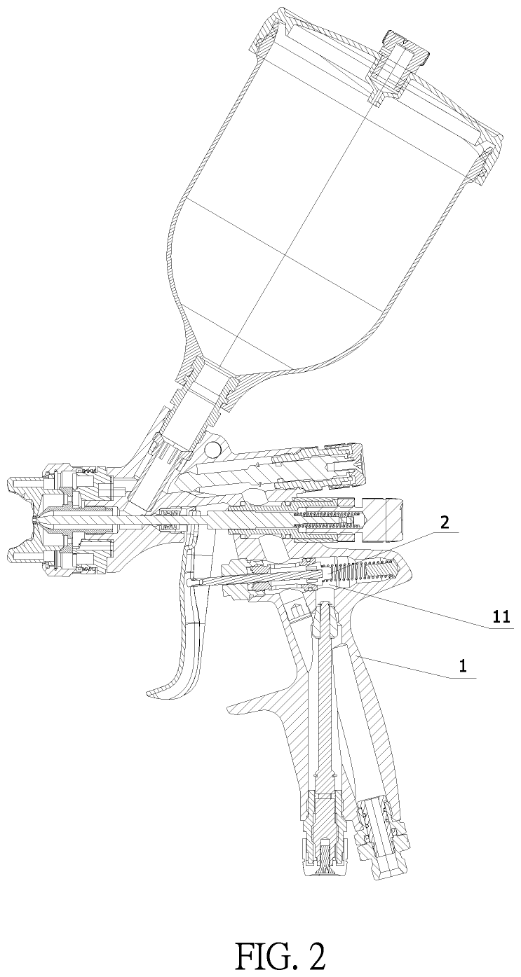

FIG. 3 is an enlarged view of the switch valve in FIG. 2;

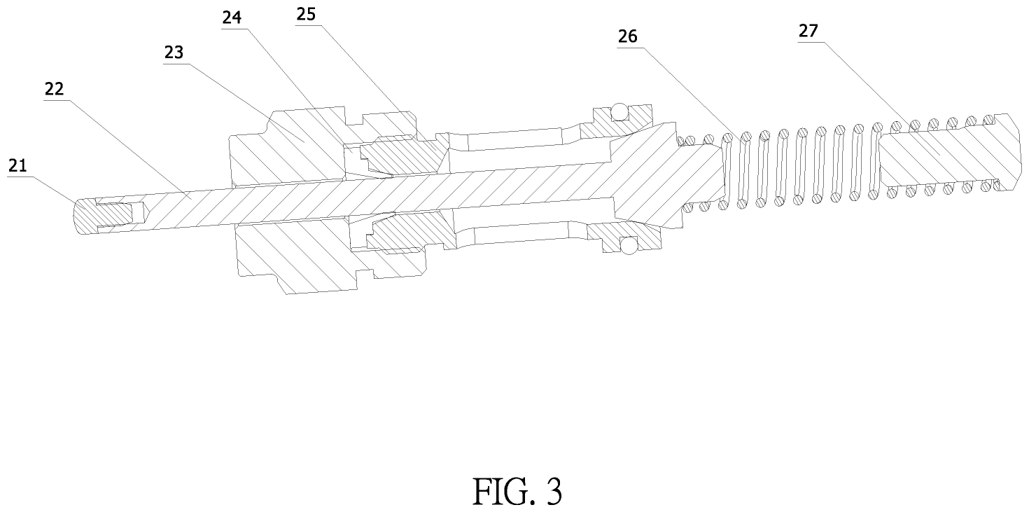

FIG. 4 is a perspective view of the switch valve;

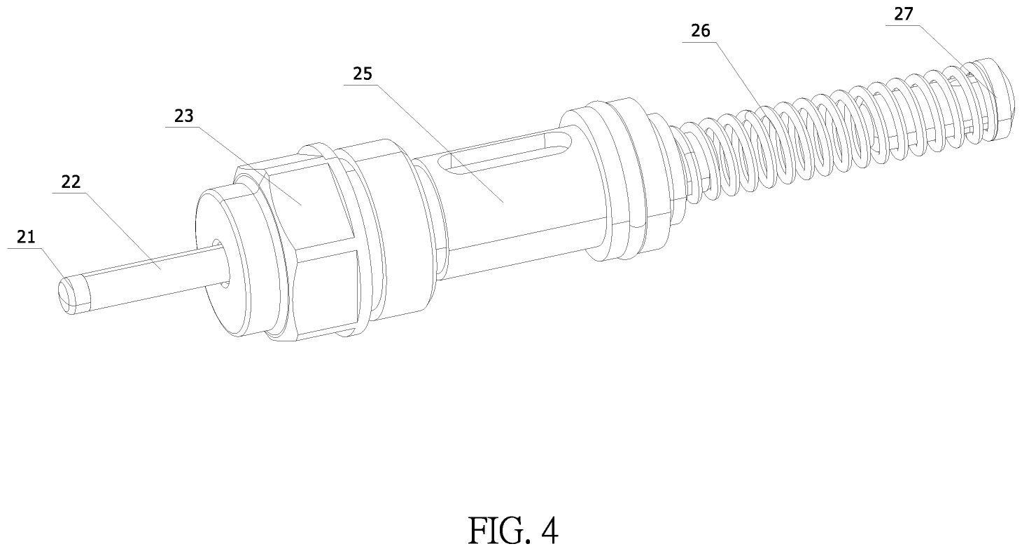

FIG. 5 is an exploded view of the switch valve.

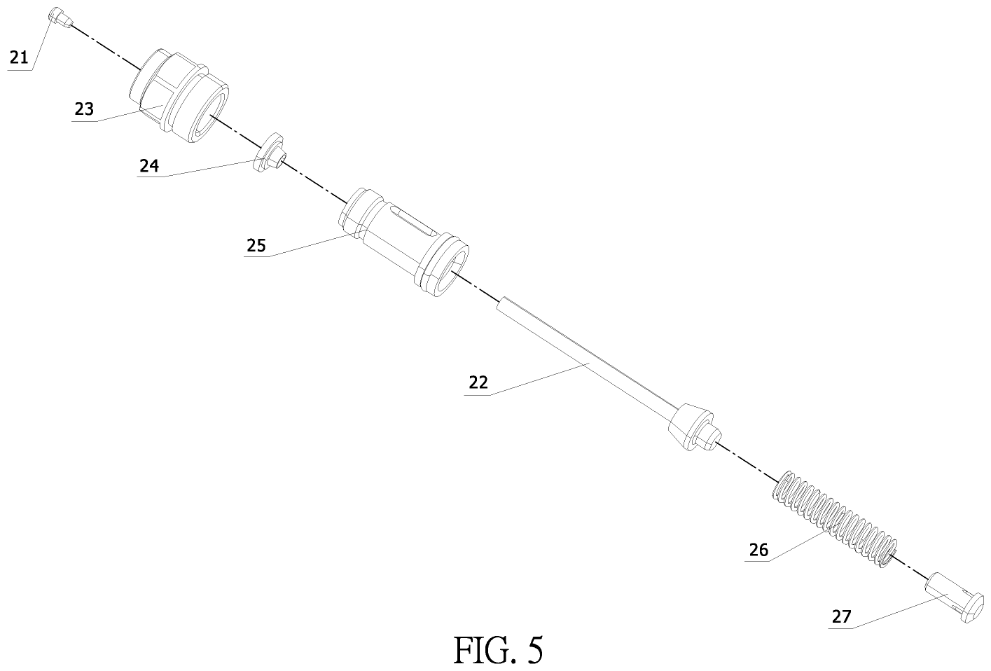

### DETAILED DESCRIPTION OF THE INVENTION

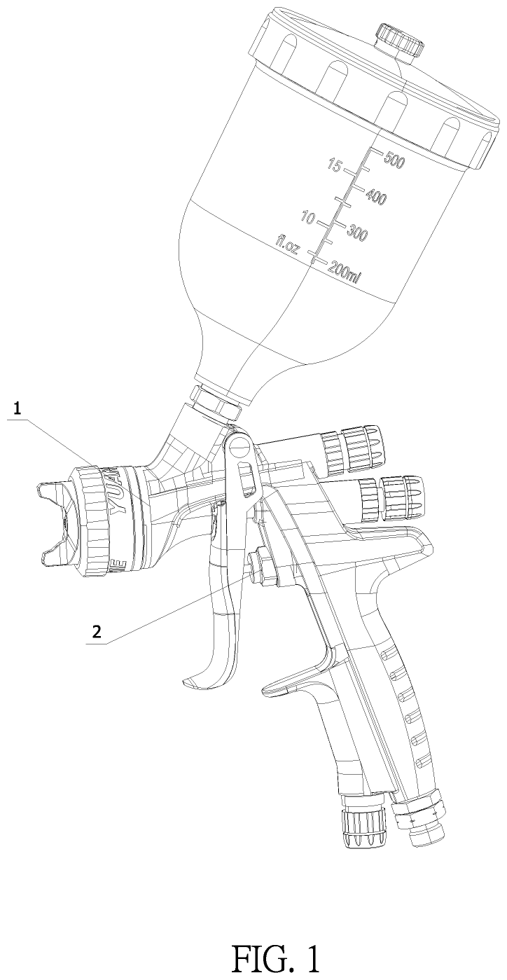

Disclosed in FIGS. 1˜5 is a pneumatic spray gun switch valve. The switch valve 2 is configured inside the switch passage 11 of the gun body 1, comprising a switch screw seat 23 that is fixed with the gun body 1, a switch seat 25 configured on the right side of the switch screw seat 23, an air valve 22 configured on the middle portions of the switch screw seat 23 and the switch seat 25, capable of moving in the axial direction, and a switch spring 26 configured on the right end of the air valve 22. The air valve 22 interacts with the switch seat 25 to open or close the air passage. The size of the switch spring 26 is smaller than the switch passage 11. The right side of the switch spring 26 is configured with a switch spring pad 27. The switch seat 25 is in threaded connection with the switch screw seat 23, and a spiracle seal ring 24 is configured at the position of connection. The threaded connection enables quick assembly, and the spiracle seal ring can seal the connecting position. The left end of the air valve 22 is configured with a switch valve 21. The switch valve 21 is made of engineering plastics. The addition of the switch valve 21 on the left end of the air valve 22 can help reduce the noise of collision between the trigger and the air valve and provide gripping comfort.

On the basis of the existing switch valve 2, in the present invention, an additional switch valve 21 is provided on the left side of the air valve 22 to reduce the noise of collision between the trigger and the air valve, and to provide gripping comfort. A switch spring pad 27 is provided on the right side of the air valve 22. The switch spring pad 27 can guide the switch spring 26 during the process of compression. The size of the switch spring is smaller than the switch passage, so that the switch spring will not have friction with the inner wall of the switch passage to cause noises.

The usage of the present invention is detailed as below:

In the existing structure, the switch passage is formed by boring the gun body 1. The inner side of the switch passage is shaped like a drill bit and is not flat. Therefore, when preparing the switch spring, the size of the switch spring shall basically match the inner wall of the switch passage to ensure stability of the switch spring. As the right side of the switch spring 26 is configured with a switch spring pad 27, the size of the switch spring 26 can be reduced appropriately to avoid direct contact between the switch spring and the inner wall of the switch passage. Moreover, the left side of the switch valve is configured with a switch valve 21 to buffer each collision of the trigger, thus enhancing the using experience of the product.

We claim:

1. A pneumatic spray gun switch valve, wherein the switch valve (2) being disposed at a switch passage (11) of a gun body (1), and comprises
a switch screw seat (23) fixedly connected with the gun body (1),
a switch seat (25) configured on a right side of the switch screw seat (23),
an air valve (22), which is disposed in a middle portion of the switch screw seat (23) and switch seat (25) and can move axially,
a switch spring (26) disposed at a right end of the air valve (22), the air valve (22) interacts with the switch seat (25) to open or close an air passage, the size of the switch spring (26) is smaller than the switch passage (11), and a right side of the switch spring (26) is configured with a switch spring pad (27).

2. The pneumatic spray gun switch valve defined in claim 1, wherein the switch seat (25) is screwed onto the switch screw seat (23) by a tread, and a spiracle seal ring (24) is configured at a connection position of the switch seat (25) and the switch screw seat (23).

3. The pneumatic spray gun switch valve defined in claim 2, wherein a left end of the air valve 2) is configured with a switch valve (21), and the switch valve (21) is made of engineering plastics.
